(19) United States
(12) Patent Application Publication
(10) Pub. No.: US 2004/0182924 A1
(43) Pub. Date: Sep. 23, 2004

(54) Method of grouping retail products for distribution and inventory control

(75) Inventors: Kathy Marie VerEecke, Atlanta, GA (US); Vanessa Marie Costigan, Atlanta, GA (US)

Correspondence Address: HOWREY SIMON ARNOLD & WHITE LLP, 750 BERING DRIVE, HOUSTON, TX, 77057, US

(73) Assignee: IN ZONE Brands, Inc., Austell, GA (US)

(21) Appl. No.: 10/391,950

(22) Filed: Mar. 19, 2003

(51) Int. Cl. G06F 17/60

(52) U.S. Cl. 235/385

(57) ABSTRACT

A method of grouping retail products for distribution is disclosed. The disclosed method includes arranging related products into groups. For inventory purposes, the products may be associated with a stock keeping unit number (SKU). In the disclosed method, Universal Product Codes (UPCs) are created for the groups by giving each group a unique item number to be shared among the individual SKUs in the group. Consequently, retail shelf space need only be obtained for one or more of the groups as opposed to the traditional method of obtaining retail shelf space for the individual product SKUs. Finally, the disclosed method includes associating products for distribution with the UPC for the group and periodically replacing products associated with the UPC with other products from the same group. The disclosed method helps to ensure constant changing of the products on the shelf, helps to reduce the need to pay mark-down funds, and helps to limit slotting allowances to be paid by the manufacturer.

### FIELD OF THE INVENTION

The present invention relates generally to a method of grouping products for distribution and inventory control and, more particularly to a method of arranging products for distribution into groups of Universal Product Codes (UPCs) so that various products can be periodically added or removed from the groups without requiring new UPCs and without effecting other products in the group and so that a manufacturer can control the distribution and availability of products based on market conditions or current inventory.

### BACKGROUND OF THE INVENTION

Universal Product Codes (UPCs) and Stock Keeping Units (SKUs) are used in the art to organize products for distribution and sale. UPCs are bar code symbols that encode a twelve-digit number. To use a UPC, a manufacturer must become a member of the Uniform Code Council, Inc. (UCC). Upon membership, the manufacturer is assigned an identification number (UCC Company Prefix having 6 digits) licensed for their use. The manufacturer can then use this UCC Company Prefix to create their own 12-digit UPC's for their products for use in the marketplace. The UPC is scanned by equipment in retail stores and is used in conjunction with computer systems to track the price, sale, and order of the products. SKUs are usually alphanumeric and are used to identify and track a particular product for inventory purposes. The SKU for a product may not be made visible to a customer.

The use of UPC's and other common practices in the art can have certain drawbacks that hinder the distribution of products. For example, a manufacturer must typically provide a new UPC when introducing a new product in the marketplace, and retailers have to authorize the new UPC associated with the new product. The retailers may also have to increase shelf space each time a new product is introduced for distribution. In this regard, retailers often charge slotting allowances, which typically refer to payments made by a manufacturer to a retailer to have its products placed on the retailer's shelves. The principal reasons why retailers charge manufactures with slotting allowances are: 1) to cover costs incurred to introduce new products; 2) to remove items that previously occupied shelf space; and 3) to recover some of the investment in the event that a product fails to sell. The most common slotting allowances are for new products—so-called new product introduction fees. Other fees that are also referred to as slotting allowances may include fees for premium product placements, such as on eye-level shelves or special displays; fees to have products remain on shelves—pay-to-stay allowances; or fees to be paid if a product fails. In addition to slotting allowances, a manufacture may need to pay a retailer markdown funds in the event that a product fails to sell. The markdown funds are paid to the retailer to defer a percentage of the cost of selling products at a marked down price.

These and other practices can hinder the distribution of products in the marketplace. Therefore, the disclosed method is directed to overcoming, or at least reducing the effects of, one or more of the problems set forth above.

### SUMMARY OF THE PRESENT DISCLOSURE

A method of grouping products for distribution and inventory control is disclosed. The disclosed method includes arranging products into related groups. In the disclosed method, each group is then given a unique item number for creating a Universal Product Code (UPC) for the group. For inventory and tracking purposes, the products may be associated with a stock keeping unit number (SKU) or the like. Using the disclosed method, products and their SKUs are then associated with the UPC for the group. The disclosed method also includes periodically associating products for distribution in the one or more groups with the UPC for that group. The products and SKUs are selected for distribution in a certain period or division. In the present disclosure, the periods or divisions are shown as regular intervals of time during the year, such as between certain months of the year. For example, this can include replacing a product associated with the UPC in one time period of the year with another product from the same group for the purposes of distributing the product in another time period of the year. Alternatively, the periods or divisions used to associate products for distribution can be dictated by less constant and more irregular factors. As used herein, “periodically associating products for distribution” is not strictly limited to associating (e.g., adding, removing, replacing, or substituting) products for distribution in set periods of time or at regular intervals. Rather, “periodically associating products for distribution” also refers to associating (e.g., adding, removing, replacing, or substituting) products for distribution in periods or divisions based on changeable time intervals, inconstant inventory of products, irregular market conditions, fluctuating considerations relevant to a manufacture, episodic events, and current marketability of products.

In the disclosed method, those SKUs for products intended for distribution in a regular or changeable period or division are linked to the UPC for the group, and the unique item number is shared among the individual SKUs or products in the group. Consequently, to distribute products into the marketplace, retail space need only be obtained for one or more of the groups as opposed to the traditional method of obtaining retail space for the individual products or SKUs. When periodically associating (e.g., adding, removing, replacing, or substituting) products for distribution, new UPC numbers are not needed, and previous UPC numbers do not need to be reintroduced. A retailer needs only to order product for the UPC, and only the products with active SKUs associated with the UPC are distributed in a given period or division. Furthermore, the manufacture can control the distribution of the product based on available inventory, marketability of products, and other factors relevant to the manufacture. Therefore, the disclosed method helps to ensure constant changing of the products on the shelf, helps to reduce the need to pay mark-down funds, and helps to limit slotting allowances to be paid by the manufacturer. Also, the disclosed method helps the manufacture to control inventory and reduces difficulties associated with arranging, tracking, and moving inventory of products.

The foregoing summary is not intended to summarize each potential embodiment or every aspect of the inventive concepts disclosed herein.

### BRIEF DESCRIPTION OF THE DRAWINGS

The foregoing summary and a preferred embodiment will be best understood with reference to a detailed description of specific embodiments, which follows, when read in conjunction with the accompanying drawings, in which:

FIG. 1 schematically illustrates a method of grouping products for distribution and inventory control according to certain teachings of the present disclosure.

FIG. 2 illustrates an example of the disclosed method having products periodically arranged in a chart format.

### DETAILED DESCRIPTION

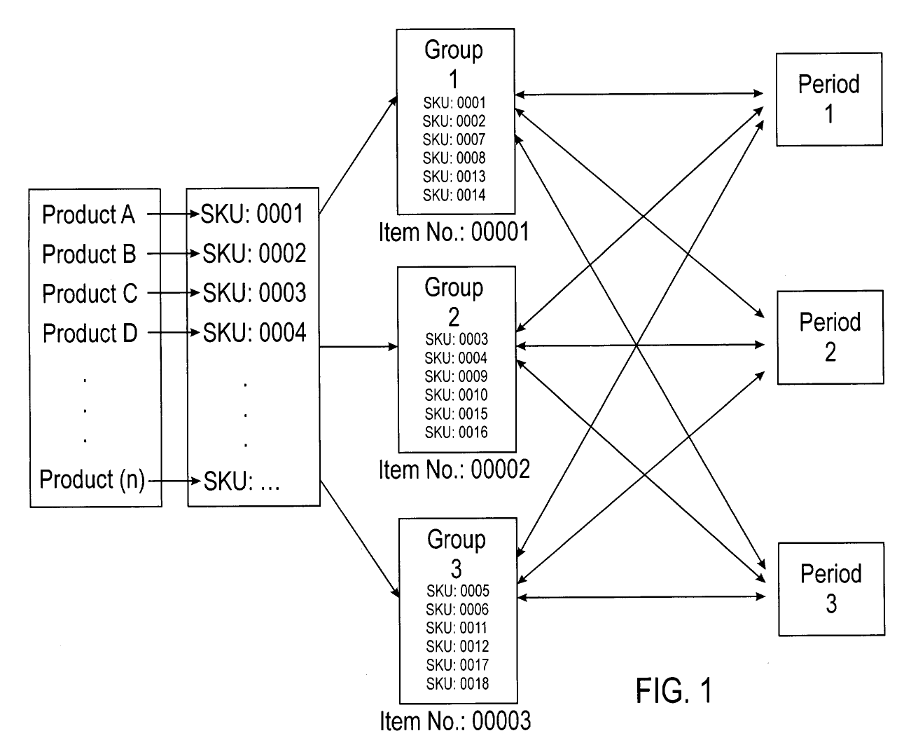

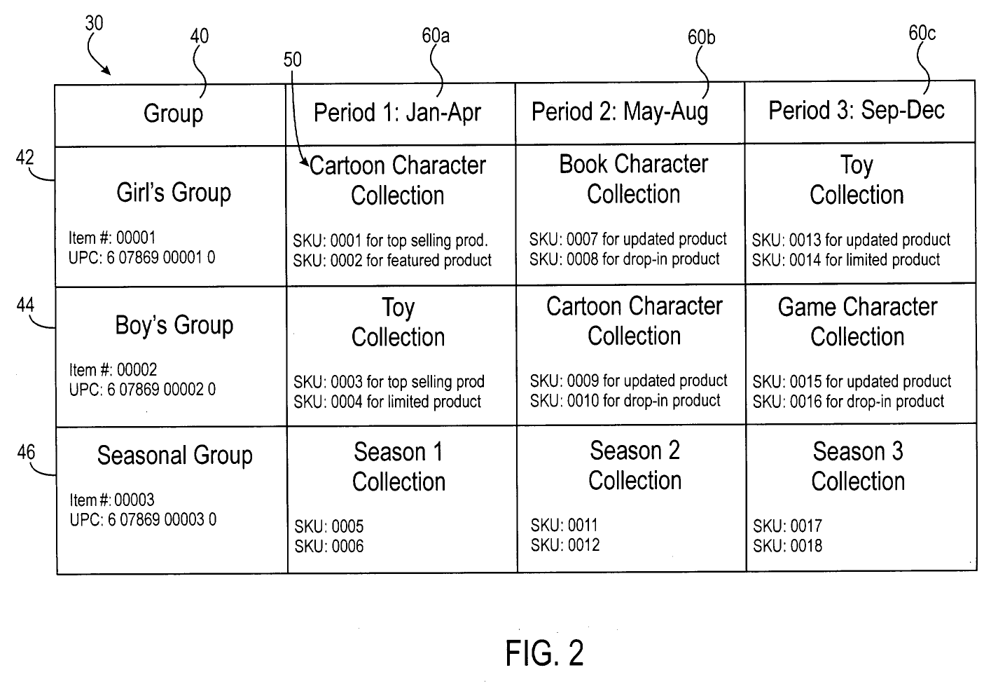

Referring to FIGS. 1 and 2, a method of grouping products for distribution and inventory control according to certain teachings of the present disclosure is illustrated.

FIG. 1 schematically illustrates steps of the disclosed method, and FIG. 2 illustrates an example of the disclosed method having products periodically arranged in a chart format 30. In FIG. 1, a first step in the disclosed method is to associate each product (Products A, B, . . . ) with a product number (SKU:0001, 0002, . . . ), such as a Stock Keeping Unit (SKU), for inventory purposes. The products with product numbers are then arranged into related groups (Groups 1, 2, 3). The groups can be based on a common theme; can be targeted to a particular consumer; or can be tied to particular annual events, for example.

In the example of FIG. 2, products have been arranged into three Groups 40, which include a Girl's Group 42; a Boy's Group 44; and a Seasonal Group 46. As will be evident, the Girl's Group 42 can include products marketed towards girl consumers, and the Boy's Group 44 can include products marketed towards boy consumers. The Seasonal Group 46 can include products related to seasonal events that occur throughout the year, such as holidays, for example. Using the disclosed method, the products can be arranged in any number of various groups depending on marketing and selling strategies. Preferably, the products arranged in a given group will have the same or similar cost or retail price so that various products within the given group can be readily replaced or substituted without significantly effecting the cost or retail price associated with the given group.

As shown in FIG. 1, each group of related products is then given a unique item number (item # 00001, 00002, 00003) to create a Universal Product Code (UPC) for each group. The unique item number is shared among the individual product numbers (SKUs) in the group and is combined with a UCC Company Prefix to create a UPC for each group. As discussed above, a manufacture of a product has exclusive use of a six-digit, UCC Company Prefix. In the example of FIG. 2, the six-digit, UCC Company Prefix is “6 07869.” The Girl's Group 42 is given the item number of “00001,” the Boy's Group 44 is given the item number of “00002,” and the Seasonal Group 46 is given the item number of “00003.” Therefore, all the SKUs (0001, 0002, 0007, 0008, 0013, and 0014) for products in the Girl's Group 42, for example, can be associated under the same UPC of “6 07869 00001 0” for that group.

The individual products within each group may be further organized into a plurality of collections for the group. In the example of FIG. 2, the Girl's Group 42 includes collections 50 of products, such as a “Cartoon Character Collection,” a “Book Character Collection,” and a “Toy Collection.” The Boy's Group 44 includes collections 50 of products, such as a “Cartoon Character Collection,” a “Game Character Collection,” and a “Toy Collection.” The collections 50 can be based on a theme or on other marketing or organizational schemes. In the present example, the SKUs for products in the Girl's Group 42 (SKU:0001 and 0002) are organized under the “Cartoon Character Collection,” and these products can include features related to a cartoon character.

To distribute the products into the marketplace, retail shelf space can then be obtained for one or more of the groups with UPCs. Obtaining retail space in this manner is different from the traditional practice of obtaining retail shelf space for individual products having individual SKUs and/or UPCs associated with them. By sharing the items numbers of the UPCs, individual products intended for distribution and having their own SKUs can be associated with or disassociated from a group's UPC at will according to marketing plans. The retailer can simply hold a designated area of their shelf for a given UPC of a group and can order products within that group with the UPC as desired.

As shown in FIG. 1, the disclosed method allows products associated with the UPC to be periodically and/or episodically arranged, added, removed, replaced, or substituted with other products intended for distribution from the same group. In other words, the individual products (SKUs) associated with the UPCs for the groups can be periodically and/or episodically arranged in a plurality of periods or division for distribution into the marketplace. In the present embodiment of the disclosed method, the periods or divisions are sections of time during the year, such as between certain months of the year (Periods 1, 2, 3). Thus, a product associated with the UPC in one time period of the year can be replaced with another product from the same group for the purposes of distributing the product in another time period of the year. In alternative embodiments of the disclosed method, the periods or divisions used to associate products for distribution can be dictated by other factors relevant to the manufacture, such as inventory of products, marketability of products, or other episodic factors. Therefore, the periods or divisions used to periodically associate the products for distribution are not strictly dictated as set intervals of time of the year. For example, a distributed product may need to be replaced by another product due depletion of inventory. In another example, a popular selling product may be distributed for extended time beyond other products in the same group due to the popularity of the product.

When periodically adding, removing, replacing, or substituting products for distribution, new UPC numbers are not needed, and previous UPC numbers do not need to be reintroduced. Therefore, the disclosed method helps to ensure constant changing of the products on the shelf, helps to reduce the frequency of paying mark-down funds, and helps to limit the amount of slotting allowances to be paid by the manufacturer. Also, the disclosed method helps the manufacture to control inventory and reduces difficulties associated with arranging, tracking, and moving inventory of products.

In the example of FIG. 2, the SKU:0001 for a top selling product and the SKU:0002 for a featured edition product are slotted for distribution in Period 1 of the year for January through April. However, these products are replaced by the SKU:0007 for an updated product and the SKU:0008 for a drop-in product slotted for distribution in Period 2 of the year for May through August. These products (SKU: 0001, 0002, 0007, and 0008) will be associated with the same UPC, namely “6 07869 00001 0.” Thus, the periodic changes in the products slotted for distribution can be performed without requiring a new UPC to be introduced into the marketplace or an old UPC to be reintroduced. In addition, the periodic changes in the product slotted for distribution can be done without effecting the other products, SKUs, UPCs, groups, or collections.

In addition to the ability of adding or removing products slotted for distribution periodically in a group, entire collections for the groups can be periodically arranged. In the example of FIG. 2, the “Season 1 Collection” can be related to a particular holiday falling within Period 1 of the year between January and April. The “Season 2 Collection” may be related to a seasonal event occurring within the months of May and August. Therefore, all the SKUs in the “Season 2 Collection” can replace the SKUs in the “Season 1 Collection” when Period 2 begins. In another example, the “Cartoon Character Collection” in the Boy's Group 44 may be slotted for distribution in Period 2 of the year to coincide with a new movie release. This collection can then be replaced by products of the “Game Character Collection” slotted for distribution in Period 3 of the year to coincide with the introduction of a new game on the market.

With the ability of periodically removing and replacing products and collections within the groups, the disclosed method allows a manufacturer to control which of their products are slotted for distribution and are available on the retailer's shelves at any given time. The manufacturer can then ensure constant changing of the products on the shelf. Consequently, the selection of products will always be fresh and up-to-date for the consumer. Outdated products or inactive SKUs can be dropped for distribution from the groups in future periods without affecting the UPC's, other products, or SKUs. Typically, products that have been on the shelf for an extended period or that are out of season are marked-down to facilitate their sale in the marketplace. In the art, retailers may require the manufacture to pay markdown funds to defer a percentage of the cost of selling products at a marked down price. With the disclosed method, the necessity for traditional mark-down funds can be avoided by slowly seeding products for distribution in between time periods so that the old product SKUs can be faded out as the new product SKUs are entered into the group. Furthermore, the disclosed method helps to avoid multiple slotting allowances or fees for the individual products. As discussed above, slotting allowances are fees paid by a manufacturer to a retailer to stock, display, and support a product, to have products remain on shelves, or to defer costs if a product fails, for example. With the disclosed method, the retailer does not have to authorize a new UPC for each introduction of a new product. In addition, the retailer does not have to increase shelf space each time a new item is introduced.

It is intended that the disclosed method include all modifications and alterations to the full extent that they come within the scope of the following claims or the equivalents thereof.

What is claimed is:

1. A method of grouping products comprising the steps of:
a) arranging products into a plurality of groups;
b) creating a product code for each group;
c) obtaining retail space for one or more of the groups; and
d) periodically associating products for distribution in the one or more groups with the product code for that group.

2. The method of claim 1, further comprising the step of associating each product with a product number for inventory purposes.

3. The method of claim 2, wherein the product number is a Stock Keeping Unit.

4. The method of claim 1, wherein step (b) comprises the step of giving each group a unique item number to be shared among the products for distribution in the group.

5. The method of claim 4, wherein step (b) comprises the step of combining the unique item numbers of the groups with a Universal Code Council Company Prefix.

6. The method of claim 1, further comprising the step of arranging the products in each group into one or more collections.

7. The method of claim 6, further comprising the step of associating one or more collections of products in each group for distribution with the product code for that group.

8. The method of claim 7, wherein each collection is based on a theme.

9. The method of claim 7, further comprising periodically replacing a collection associated with the product code with another collection for distribution from the same group.

10. The method of claim 1, wherein the step (d) comprises the step of replacing a product associated with the product code in one time period with another product from the same group for the purposes of distributing the product in another time period.

11. A method of grouping products comprising the steps of:
a) arranging products into a plurality of groups;
b) creating a Universal Product Code for each group;
c) obtaining retail space for one or more of the groups; and
d) periodically associating products for distribution in the one or more groups with the Universal Product Code for that group.

12. The method of claim 11, further comprising the step of associating each product with a product number for inventory purposes.

13. The method of claim 12, wherein the product number is a Stock Keeping Unit.

14. The method of claim 11, wherein step (b) comprises the step of giving each group a unique item number to be shared among the products for distribution in the group.

15. The method of claim 14, wherein step (b) comprises the step of combining the unique item numbers of the groups with a Universal Code Council Company Prefix.

16. The method of claim 11, further comprising the step of arranging the products in each group into one or more collections.

17. The method of claim 16, further comprising the step of associating one or more collections of products in each group for distribution with the Universal Product Code for that group.

18. The method of claim 17, wherein each collection is based on a theme.

19. The method of claim 17, further comprising periodically replacing a collection associated with the Universal Product Code with another collection for distribution from the same group.

20. The method of claim 11, wherein the step (d) comprises the step of replacing a product associated with the Universal Product Code in one time period with another product from the same group for the purposes of distributing the product in another time period.
